(19) United States
(12) Patent Application Publication
(10) Pub. No.: US 2012/0110012 A1
(43) Pub. Date: May 3, 2012

(54) Estimating User-Perceived TCP Throughput

(75) Inventors: Tamas Borsos, Budapest (HU); László Kovács, Martonvasar (HU)

(73) Assignee: TELEFONAKTIEBOLAGET L M ERICSSON (PUBL), Stockholm (SE)

(21) Appl. No.: 13/378,820

(22) PCT Filed: Jun. 25, 2009
(86) PCT No.: PCT/EP09/04597

§ 371 Date: Jan. 12, 2012

(51) Int. Cl. G06F 17/30

(52) U.S. Cl. 707/770; 707/E17.014

(57) ABSTRACT

A passive network measurement based solution for estimating user-perceived TCP throughput in a mobile PS network is provided. Instead of direct detection of TCP bulk data periods and server side limitations, the diversity of TCP connection end-points on the Internet side is exploited. The TCP throughput at an interface of the mobile network from/to each server on the Internet side during a file/object transfer of bulk date periods is monitored and measured and the servers are ranked according to their throughput statistics. The top performing servers are grouped into classes by statistical algorithms. The throughput samples from the users towards the servers belonging to the top group of highest average throughput are averaged to obtain a proper estimation for the user-perceived TCP throughput.

### TECHNICAL FIELD

The invention relates to a packet-switched (PS) communication network, especially a mobile communication network transferring data packets by Transmission Control Protocol (TCP).

### BACKGROUND ART

User traffic throughput is one of the most important performance measures in PS mobile communication networks. In communication networks, throughput is the average rate of successful object delivery over a communication channel. This data may be delivered over a physical or logical link, over a wireless channel, or that is passing through a certain network node, such as data passed between two specific computers. The throughput is the primary measure of mobile broad band service quality and usually measured in bits per second (bit/s or bps), and sometimes in data packets per second or data packets per time slot.

It is essential for every PS network operator to ensure the highest throughput for end-users. The majority of the traffic (90%-95%) in these networks is carried over TCP, which fundamentally determines the end-user experience for all applications using this transmission protocol. Therefore, the measurement of TCP throughput is a key task to assure satisfactory PS service performance. There are three basic ways of measuring TCP throughput in operational PS networks. The first possible way is the active testing. This is the most common way of measuring throughput because of its simplicity. In this case, certain terminals dedicated for such tasks generate File Transfer Protocol (FTP) traffic which uses TCP as a transport protocol and measure the throughput. Standard ETSI TS 102 250-2 Speech Processing, Transmission and Quality Aspects (STQ) relates to Quality of Service (QoS) aspects for popular services in GSM and 3G networks. In the standard specification a parameter of FTP Mean Data Rate is defined (paragraph 6.1.7) for measuring throughput. After a data link has been successfully established, this parameter describes the average data transfer rate measured throughout the entire connect time to the service. The target file to download is located on a server with good connection to the measured network, so that the throughput bottleneck should be in the network to test its capabilities.

The second way is the subscriber terminal measures. In this case performance measurements are directly done in the terminal of a subscriber. Such measurements can be carried out by e.g. Ericsson's TEMS phones, or by the solution described in patent publication WO 2000/67507 A, which introduces the capability of monitoring service and network performance in mobile terminal remotely and provides best opportunity for network operator to measure customer perceived quality.

The third way is passive measurements carried out in the network. The traffic is measured by nodes or captured at certain interfaces in the network, and performance indicators are obtained by processing this information. As shown in several related work, performance indicators are possible to define such that end-user perceived quality is well approximated by the indicators. Solution is known for this type of measurement in patent specification U.S. Pat. No. 6,807,156.

It is obvious that user-perceived performance can be best observed in the user terminal. In spite of this, the third method has numerous advantages over the first two, since no specific terminals are needed and all terminals in a live network can be observed. Moreover, passive measurements are cost-efficient and large-scale monitoring is possible, because a few measurement points can cover a large part of a network. It is also advantageous that it provides much better estimation for user experience, since the measurement is based on actual user locations and user equipments such as type and configuration.

It is known from the practice at the same time that in throughput estimation methods based on passive network monitoring TCP data rate calculations are part of several deep packet inspection network traffic monitoring tools and systems. However, different implementation details of TCP rate provide different value for network performance evaluation.

The useful performance measure is not the bitrate of any TCP connections, but the typically achieved TCP throughput during an FTP-like file/object transfer (upload or download), i.e. during a file/object transfer of bulk data periods. Identification of such file transfers is difficult. However, FTP protocol is rarely used, so FTP samples will not represent the user population well enough. HTTP-based applications, on the other hand, have very diverse functionalities: web browsing, stored content streaming, real-time streaming, social networking, chat, voice over IP, etc. It is difficult to select those connections/transactions that are FTP-like file/object transfers.

Moreover, a network operator is primarily interested in the performance of its own network, excluding the potential bottlenecks caused by poor Internet paths (with extremely high packet loss/delay) or server/client side limitations (TCP server socket size, receiver window settings, etc.). This analysis is not possible by methods used in performance analysis tools today.

There is a widespread knowledge about this kind of estimator for end-to-end throughput of wireless networks, as it is described in patent publication WO 2005/098461 A2. The patent publication presents architecture to dynamically measure and estimate the throughput perceived by a user during a connection in real-time in a wireless network system. The architecture includes a gateway node, which the measured traffic must flow through. It also includes throughput estimators (TE) for determining the throughput available for applications. There are several TE realizations described in the document. The most related TE is the “TCP trace TE”, where the content size and the bulk data transfer time for content delivery are used for throughput calculation. However, it is not described, how the TE identifies the proper content to measure throughput.

In UK Patent Application GB 2437012 A, user throughput is estimated in the terminal equipment based on the received signal quality. It applies a throughput function calculation function to translate the signal quality to throughput. This functionality resides in the terminal, so it is not capable of network monitoring on wide user basis. Furthermore, it does not measure the throughput directly, but the throughput is a result of an estimation using a theoretical protocol model which is less trustworthy.

In the paper “A Large-scale, Passive Analysis of End-to-End TCP Performance over GPRS”, Infocom 2004, passive measurement methodology is described for TCP throughput estimation. It assumes, however, that the traffic over HTTP is always “greedy”, FTP-like download. Today this assumption is not valid. Furthermore, it measures the end-to-end TCP throughput, possibly including the effects of congested Internet paths and server limitations.

Thus there is a particular need to give a passive network measurement based solution for determining user-perceived TCP throughput, where the bottlenecks outside the operated mobile network are eliminated. In other words, the measure should be comparable to the FTP Mean Data Rate specified in standard ETSI TS 102 250-2, widely used active FTP measurements from/to a reference FTP server.

The existing passive measurement solutions fall short of the above requirements, because they all lack two important functionalities. These are a.) to detect TCP bulk data periods, which can be used for valid throughput calculation (FTP-like download, not, e.g., telnet connection or rate-controlled application stream), and b.) to estimate the operated network performance, and reduce the effects of other components in the end-to-end path, e.g., congested Internet links or server parameter settings optimized for fix and not for mobile access.

### SUMMARY OF INVENTION

Accordingly, it is the object of the invention to give a passive network measurement based solution for estimating user-perceived TCP throughput in a mobile PS network, where the bottlenecks outside the operated mobile network are eliminated.

The invention is based on the recognition that instead of direct detection of “bandwidth-greedy”, FTP-like, TCP bulk data periods and server side limitations, it is possible to make use of the diversity of TCP connection end-points on the Internet side, typically, content delivery servers. This invention monitors and measures the TCP throughput at an interface of the mobile network from/to each server on the Internet side during a file/object transfer of bulk date periods and ranks the servers according to their throughput statistics. The top performing servers are expected (i) to store and provide content for bulk, greedy TCP download only, (ii) to be free of any server-side performance bottleneck and (iii) to have good Internet connection to the measured mobile network. The top performing servers are grouped into classes by statistical algorithms. The throughput samples from the users towards the servers belonging to the top group of highest average throughput are averaged to obtain a proper estimation for the user-perceived TCP throughput in a PS mobile network.

In another aspect, the present invention is directed to a device carrying out the estimation of the user-perceived TCP throughput. The device comprises an Interface monitoring and parsing module that sends Performance records to a Performance database. A Server classification module receives Server information from the Performance database and to sends Database extension information to the Performance database. A Performance estimation module receives extended performance records from the Performance database.

The performance records include user specific information, throughput measure information, and server information for ranking the servers, and classification information for classifying the servers.

In advantageous embodiments, the user specific information is a user ID, or it includes maximum receiver window size during the connection, or includes user equipment category. Server information may include server address, or DNS name, or content type or service type information. Performance records may further comprise mobile network and internet side specific statistics information.

The most important advantage of the invention is that it is an application unaware passive method for the estimation of TCP throughput offered by a mobile PS network.

It is also advantageous that there is no need for DPI (Deep Packet Inspection) beyond TCP layer.

Another advantage is that it automatically selects TCP downloads and TCP based applications that are able to utilize the available bandwidth. This is an inherent feature of the algorithm.

Since a few measurement points can cover a large part of the network, the invention is a cost efficient approach to examine the performance of mobile packet networks.

A further advantage is that the method gives a representative, statistically relevant result that is already comparable to active FTP drive tests.

### BRIEF DESCRIPTION OF DRAWINGS

For a more complete understanding of the invention, reference is made to the following detailed description taken in conjunction with the accompanying drawings wherein:

FIG. 1 schematically illustrates a system model for estimating user-perceived TCP throughput in a mobile PS network according to an embodiment of the present invention.

FIG. 2 is a schematic flowchart for illustrating method steps performed in an embodiment of the present invention.

FIG. 3 is a schematic block diagram illustrating a device embodying the present invention.

### DESCRIPTION OF EMBODIMENTS

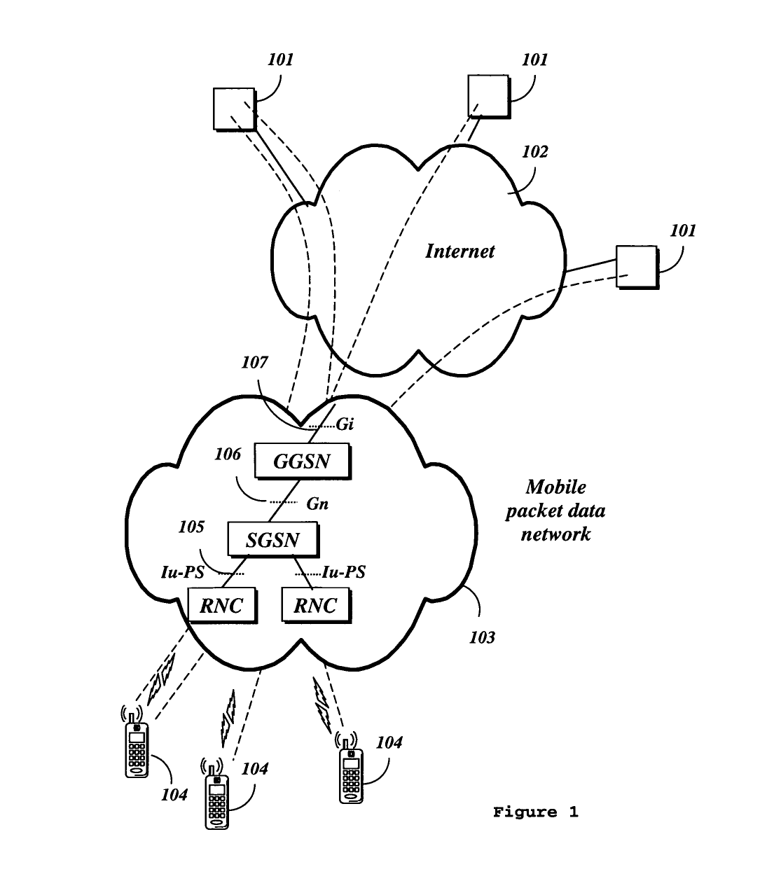

In FIG. 1, users 104 of a mobile PS data network 103 have connections (dashed lines) to servers 101 attached to Internet 102. As it is illustrated, each user 104 can send and receive packet data to/from each server 101 through Iu-PS, Gn and Gi interfaces, indicated by 105, 106 and 107, respectively.

The Iu-PS interface 105 is specified between a Serving GPRS Support Node (SGSN) and a Radio Network Controller (RNC) which is the point of connection of a GPRS core network to the access network of the users 104.

The Gn interface 106 is a reference point between the SGSN and a Gateway GPRS Support Node (GGSN) and used for PDP Context activation and for transport of user data.

The Gi interface 107 serves as a reference point at which a GPRS core network connects to the internet. Alternatively, corporate customers may have a direct connection to this point for higher security. This reference point is normally just an IP network, though a tunneling protocol may be used instead.

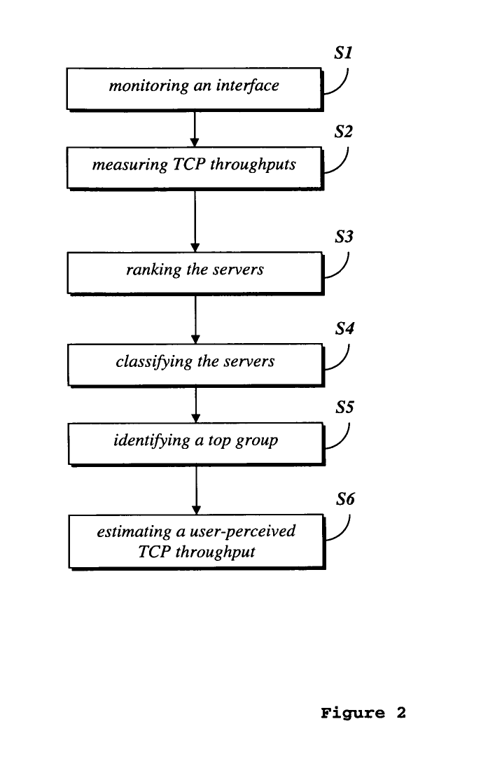

FIG. 2 shows the method steps for estimating user-perceived TCP throughput in a mobile packet-switched data network.

In the first step, S1 an interface of the mobile network is monitored. Gi, or Gn, or Iu-PS interface of the mobile network are appropriate for such a monitoring. In the second step S2, TCP throughputs on the interface from/to each server on the Internet side during a file/object transfer of bulk date periods are measured. In the third step S3, the servers according to their throughput statistics are ranked. In the forth step S4, the servers are classified into groups. In the fifth step S5, a top group of servers having the highest average throughput is identified. In the final step S6, a user-perceived TCP throughput in the packet-switched mobile network by averaging the throughput samples from the users towards the top group servers is estimated.

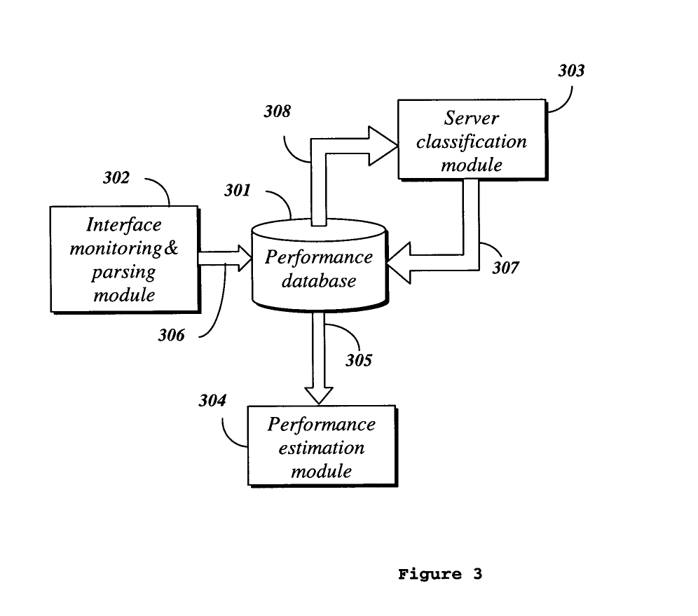

A possible embodiment of a device for the estimation of the available TCP throughput offered by a mobile packet-switched network can be seen on FIG. 3.

An Interface monitoring and parsing module 302 captures traffic on standardised interfaces (e.g. Iu-PS, Gn, Gi) and creates performance records 306 of TCP connections by parsing through the captured user packet flows. The performance records 306 contain the following important fields (see Table 1):

TABLE 1
performance record

| | | | |
|---|---|---|---|
| U | T | N | S |

in which
U: user specific information that can be extracted from the traffic traces (e.g. maximum receiver window size during the connection, user equipment category)
T: throughput measure information
N: mobile network and internet side specific statistics (e.g. loss, delay, etc.)
S: server information that can be extracted from the traffic passing through the monitoring points, e.g. sever address, or Domain Name Server (DNS name), content type, service type.

There are other performance influencing properties that can not be retrieved from packet traces explicitly. E.g. the server window size or different rate control mechanisms at the server (rate control by loss, rate control in bursts) have also influence on the achievable throughput. Retrieving this information from packet traces would be a complex task but here is not required because a Server classification module 303 assigns the servers having these kinds of “hidden” limitations into another class than those servers who have the least limitation that influences the performance of the network.

The TCP performance records, generated by the Interface monitoring and parsing module 302, are stored in a Performance database 301. The performance database 301 stores the performance records, created by the Interface monitoring and parsing module 302, and forwards them to the Server classification module 303. The Server classification module 303 performs a classification method on the TCP performance records and extends the records stored in the Performance database 301. The important fields of the extended performance records can be seen in Table 2.

TABLE 2
extended performance record

| | | | | |
|---|---|---|---|---|
| U | T | N | S | G |

in which
U, T, N, S fields are the same as in Table 1. The G fields contain information about the output of the Server classification module 303.

The Server classification module 303 reads server information 308 from the Performance database 301 and forms statistical data sets from the throughput measurements towards each server from where users initiated download during the measurement period. As an option the basis of the classification can be any attribute set (e.g. {server identifier, user equipment category, receiver window size}). The default classification is based only on the server identifier.

The classification method forms server groups from the data sets belonging to different servers (or attribute sets) by performing statistical tests on the data sets. Data sets whose throughput measurements do not differ significantly will belong to the same group.

A possible way of the comparison of the means is the one-way analysis of variance (ANOVA) method (at α percent significance level). The goal of this statistical method is to compare the means of several populations. First we select the server with the highest sample number (generator server) and all those whose means do not differ significantly from the generator server (i.e. the one-way ANOVA method at a percent significance level does not state that the means are different) to form a server group. After that we delete the selected servers from the server list and restart the grouping process.

After classification the Server classification module 303 extends the performance records 307 in the Performance database 301 by grouping information fields (G fields in Table 2). These fields contain information about the output of the classification method, e.g. in which server group the TCP measurement record belongs, list of the members of the server group, aggregate loss and delay statistics from the server group.

A Performance estimation module 304 is to read out extended performance records 305 from the Performance database 301, evaluate these records, and provide statistics about the performance of the mobile network.

For example if we want to know the average TCP throughput of a mobile PS network, e.g. a 3G mobile network, we select the server group with the highest average throughput. This group contains a number of TCP performance records from several hundreds of users toward a group of servers that have the fewest server side limitation factors that influence the performance of the network. These servers are also expected to have “good” internet side delay and loss conditions. So the average of the throughput measures belonging to the servers of the top group, i.e. the group with the highest average throughput, represents the capacity of the mobile packet network (e.g. a 3G mobile network). The Performance estimation module 304 can provide other useful information, such as the 95 percent confidence interval for the average throughput, the average network side delay and loss, etc., from the top group, too.

For example an operator would be curious to know the available TCP throughput of a High Speed Downlink Packet Access (HSDPA) network for different user equipment (UE) category terminals. UE category 12 terminals support only Quadrature Phase Shift Keying (QPSK) modulation scheme (with a maximum data rate of about 1.5 Mbps) and the available throughput is possibly less than that for UE category 6 terminals who can use 16 Quadrature Amplitude Modulation (16QAM), too (the maximum data rate for UE category 6 terminals is about 3 Mbps). In this case the attribute set by which we have to execute the classification method is the server identifier, user equipment category pair.

Another influence factor could be the size of the receiver window. If an operator wants to know the difference in the throughput offered by the network for users with correct client settings and for users with wrong client settings (with too small receiver window size) than the receiver window size should also be added to the attribute set of the classification method.

Although the present invention has been described in detail with reference to only a few exemplary embodiments, those skilled in the art will appreciate that various modifications can be made without departing from the invention. Accordingly, the invention is defined only by the following claims, which are intended to embrace all equivalents thereof.

1.-15. (canceled)

16. A method for estimating user-perceived Transmission Control Protocol (TCP) throughput in a mobile packet-switched data network, the method comprising:
monitoring an interface of the mobile network;
measuring TCP throughput on the interface of each of a plurality of servers on an Internet side during a data transfer of bulk data periods;
ranking the servers according to their measured throughput;
classifying the servers into groups;
identifying a top group of servers having the highest average throughput;
estimating the user-perceived TCP throughput in the operated packet-switched mobile network by averaging the measured throughput from the users towards the top group of servers.

17. The method of claim 16 in which the interface comprises at least one of a Gi interface, Gn interface, and an Iu-PS interface of the mobile network.

18. The method of claim 16 wherein ranking the servers includes creating performance records of TCP connections, the performance records including:
user specific information;
throughput measure information; and
server information.

19. The method of claim 18 wherein the user specific information comprises a user ID.

20. The method of claim 18 wherein the user specific information includes a maximum receiver window size during the corresponding TCP connection.

21. The method of claim 18 wherein the user specific information includes a user equipment category.

22. The method of claim 18 wherein the server information includes a server address or Domain Name Server (DNS) name.

23. The method of claim 18 wherein the server information includes content type or service type information.

24. The method of claim 18 wherein the performance records further comprise mobile network and internet side specific statistics information.

25. The method of claim 18 wherein classifying the servers into groups comprises:
comparing mean values of the throughput measure information of the performance records by a statistical analysis;
creating extended performance records with server classification information based on the statistical analysis.

26. The method of claim 25 in which the statistical analysis comprises a one way Analysis of Variance (ANOVA) analysis.

27. A device for estimating user-perceived Transmission Control Protocol (TCP) throughput in a mobile packet-switched data network, the device comprising:
an interface monitoring and parsing module configured to send performance records to a performance database;
a server classification module configured to receive server information from the performance database and to send database extension information to the performance database; and
a performance estimation module configured to receive extended performance records from the performance database.

28. The device of claim 27 in which the interface monitoring and parsing module is connected to at least one of a Gi interface, a Gn interface, and an Iu-PS interface of the mobile network.

29. The device of claim 27 in which the performance database includes extended performance records of:
user specific information;
throughput measure information;
server information; and
information about server classification.

30. The device of claim 27 in which the database extension information includes information about server classification.
